(19) United States
(12) Patent Application Publication
(10) Pub. No.: US 2024/0270323 A1
(43) Pub. Date: Aug. 15, 2024

(54) ADJUSTABLE CAB FOR A STAND-ON SKID STEER VEHICLE

(71) Applicant: Ariens Company, Brillion, WI (US)

(72) Inventors: Jeffry J. Radke, Appleton, WI (US); Steve Becker, Litchfield, MN (US)

(21) Appl. No.: 18/438,151

(22) Filed: Feb. 9, 2024

Related U.S. Application Data
(60) Provisional application No. 63/484,377, filed on Feb. 10, 2023.

(51) Int. Cl. B62D 27/06; B60K 15/07; B62D 49/06; B62D 51/02

(52) U.S. Cl. CPC B62D 27/06; B60K 15/07; B62D 51/02; B62D 49/065

(57) ABSTRACT

A stand-on utility machine includes a frame having a front end and a rear end, a prime mover supported by the frame, a skid steer drive assembly operably coupled to the prime mover, and a plurality of ground engaging elements supporting the frame with respect to a ground surface and operable under the influence of the skid steer drive assembly. The machine further includes an operator interface positioned on top of a control tower and an operator platform configured to support an operator so the operator interface is accessible by the operator standing on the platform. A portion of the operator platform being rearward a portion of the ground engaging elements. The machine further includes a cab removably coupled to the frame proximate the operator interface, the cab being movable between an operating position and one or more of a storage position or a transportation position.

### CROSS-REFERENCE TO RELATED APPLICATIONS

This application claims priority to U.S. Provisional Patent Application No. 63/484,377 filed on Feb. 10, 2023, the entire content of which is incorporated herein by reference.

### BACKGROUND

The present invention relates to a stand on utility vehicle, such as a snow removal machine, having a cab that is movable between an operating position and one or both of a storage position or a transportation position.

### SUMMARY

In one aspect, the invention provides a stand-on utility machine including: a frame having a front end and a rear end; a prime mover supported by the frame; a skid steer drive assembly operably coupled to the prime mover; a plurality of ground engaging elements supporting the frame with respect to a ground surface, the ground engaging elements being operable under the influence of the skid steer drive assembly to move the utility machine over the ground surface; an operator interface positioned on top of a control tower; an operator platform coupled to the frame and configured to support an operator so the operator interface is accessible by the operator standing on the platform, a portion of the operator platform being rearward a portion of the ground engaging elements; and a cab removably coupled to the frame proximate the operator interface, the cab being movable between an operating position and one or more of a storage position or a transportation position.

In another aspect, the invention provides a stand-on utility machine including: a frame having a front end and a rear end; a prime mover supported by the frame; a plurality of ground engaging elements supporting the frame with respect to a ground surface, the ground engaging elements being operable under the influence of the prime mover to move the utility machine over the ground surface; an operator interface positioned on top of a control tower; an operator platform coupled to the frame and configured to support an operator so the operator interface is accessible by the operator standing on the platform, a portion of the operator platform being rearward a portion of the ground engaging elements; and a cab removably coupled to the frame proximate the operator interface, the cab being movable between a first position where a first height is defined between the operator platform and an uppermost portion of the cab and a second position where a second height is defined between the uppermost portion of the cab and the operator platform, wherein the second height is less than the first height.

In another aspect, the invention provides a stand-on utility machine including: a frame having a front end and a rear end; a prime mover supported by the frame; a ground engaging element coupled to the frame and supporting the frame with respect to a ground surface; a plurality of ground engaging elements supporting the frame with respect to a ground surface; an operator interface positioned on top of a control tower; an operator platform coupled to the frame and configured to support an operator so the operator interface is accessible by the operator standing on the platform; and a cab coupled to the frame proximate the operator interface, the cab defining a roof that extends at least partially over the operator platform.

Other aspects of the invention will become apparent by consideration of the detailed description and accompanying drawings.

### BRIEF DESCRIPTION OF THE DRAWINGS

FIG. 1 is a front perspective view of a stand-on utility machine according to the present invention.

FIG. 2 is a rear perspective view of the stand-on utility machine of FIG. 1.

FIG. 3 is top view of the stand-on utility machine of FIG. 1.

FIG. 4 is a bottom view of the stand-on utility machine of FIG. 1.

FIG. 5 is a rear perspective view of the stand-on utility machine of FIG. 1 having an implement coupled to the implement support assembly and supported in front of the machine.

FIG. 6 is front perspective view a cab for the stand-on utility machine of FIG. 1.

FIG. 7A is rear perspective view the cab for the stand-on utility machine of FIG. 1.

FIG. 7B is rear perspective view a support frame of the cab of FIG. 6.

FIG. 8 is rear perspective view of a portion of the stand-on utility machine of FIG. 1 illustrating bracket assembly for the cab of FIG. 6.

FIG. 9 is front perspective view of a portion of the stand-on utility machine of FIG. 1 illustrating a front bracket for the cab of FIG. 6

FIG. 10 is a side view of the stand-on utility machine of FIG. 1, illustrating the cab in a first, operating position.

FIG. 11 is a front view of the stand-on utility machine of FIG. 1, illustrating the cab in the first, operating position.

FIG. 12 is a side view of the stand-on utility machine of FIG. 1, illustrating the cab in a second, storage or transportation position.

FIG. 13 is a front view of the stand-on utility machine of FIG. 1, illustrating the cab in the second, storage or transportation position.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

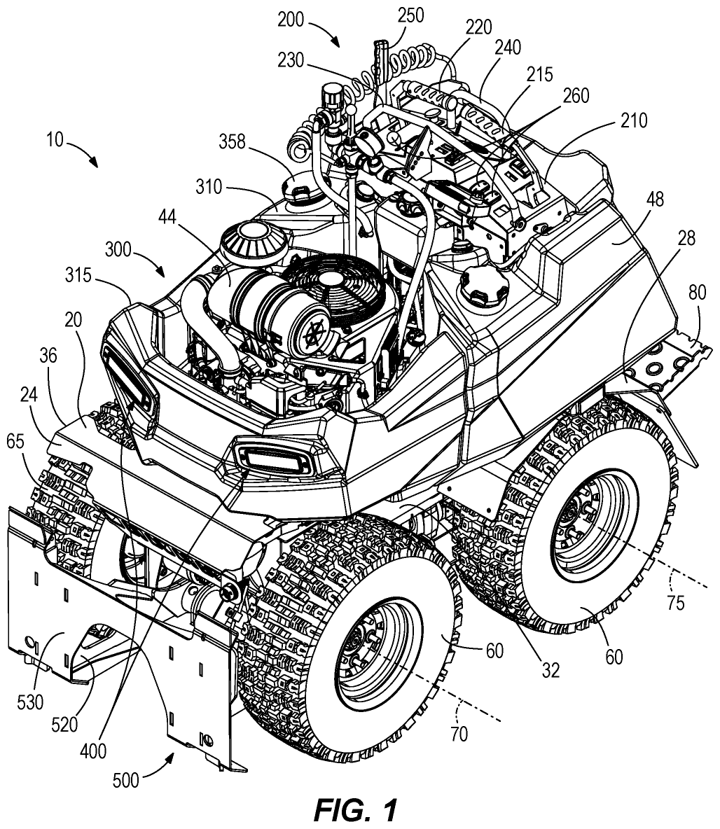

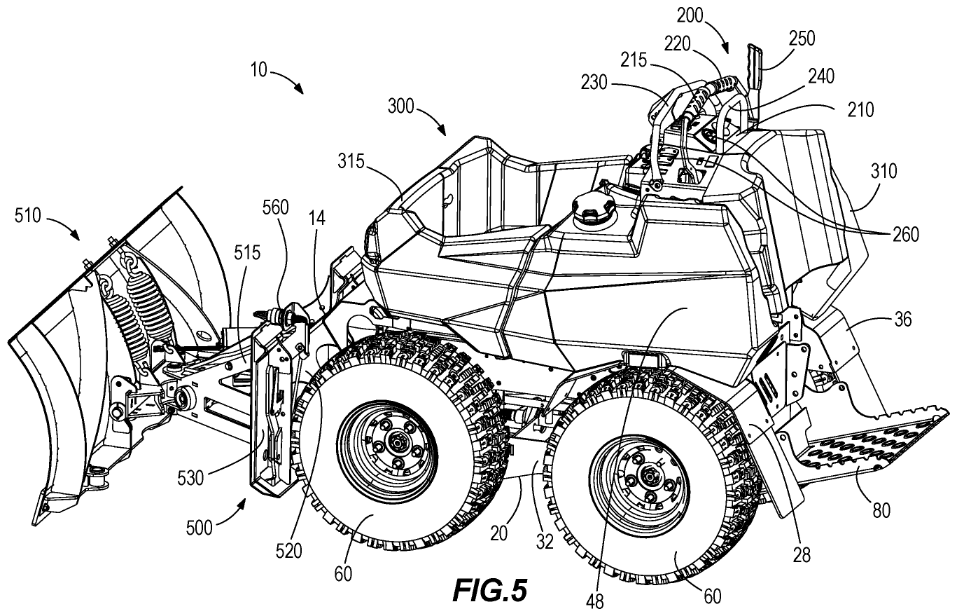

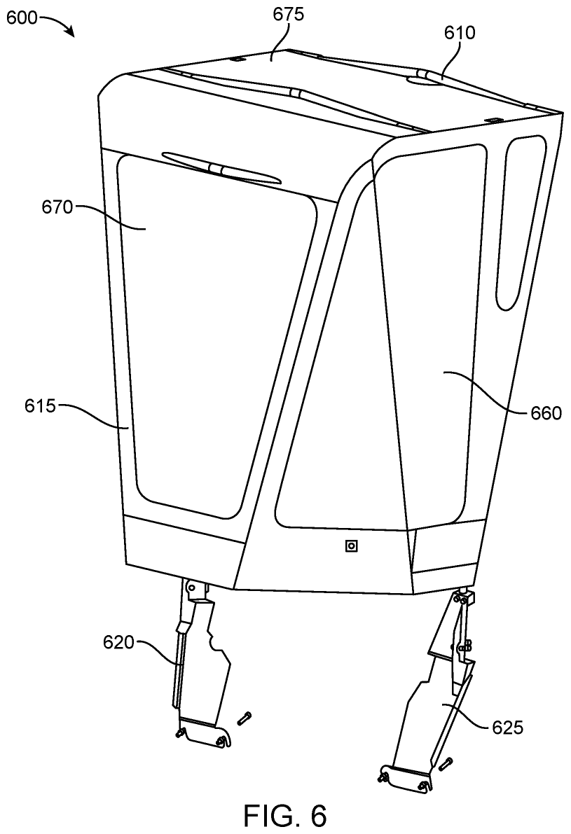

FIGS. 1-5 illustrate an exemplary embodiment of a snow removal vehicle 10 according to the present invention. In the illustrated embodiment, the snow removal vehicle is in the form of a stand-on utility machine 10 (e.g., capable of removing snow) having an implement 510 (FIG. 5) coupled to the vehicle 10. FIGS. 6-11 illustrate a cab 600 configured to be coupled to the vehicle 10. As described in more detail below, the cab 600 is configured to shelter the operator (e.g., when in an operating position) or the vehicle 10 (e.g., when in a storage or transport position).

Although the present invention is described with respect to the illustrated snow removal vehicle, it will be understood that the invention is applicable to other indoor and outdoor power equipment units and more broadly to utility machines that can be used indoors or outdoors to perform work. As such, aspects of the invention which are described as being part of the “vehicle” will be understood to be applicable to utility machines generally and the term “machine” can be substituted to for “vehicle”. Spatial terminology (e.g., “front,” “rear,” “left,” “right,” “forward,” “back,” “up,” “down,” and similar terms) will be used from the perspective of an operator during ordinary, intended operation of the utility machine. The term “side” is used to denote left, right, front and rear of a component, unless otherwise specified, as distinguished from the top and bottom of the component.

Generally speaking, utility machines of the type covered by the present invention include an implement, which encompasses any implement on such utility machine that performs work other than moving the utility machine (e.g., driving rotation of wheels or track drives). In the embodiment illustrated in FIG. 6, the implement 510 comprises a snow plow coupled to and positioned forward of the vehicle 10. In other embodiments, the implement comprises a drop spreader for ice melting particulate (e.g., salt or other snow melting crystals). In some embodiments, the drop spreader may be coupled to and positioned rearward of the vehicle. It should also be appreciated that the utility vehicle 10 may include more than one implement (e.g., both the snow plow and the drop spreader). In other embodiments, the implement comprises a rotating brush. In other embodiments, the implement comprises a snow blower. In other embodiments, the implement comprises leaf blowers, snow blowers, power brush implements, trimmers, tillers, multi-attachment vehicles, floor polishers, vacuum cleaners, wet vacs, concrete trowels, or any other indoor or outdoor work unit suitable for a given application. In other embodiments, the implement comprises combinations of the exemplary implements illustrated in the drawings or mentioned above.

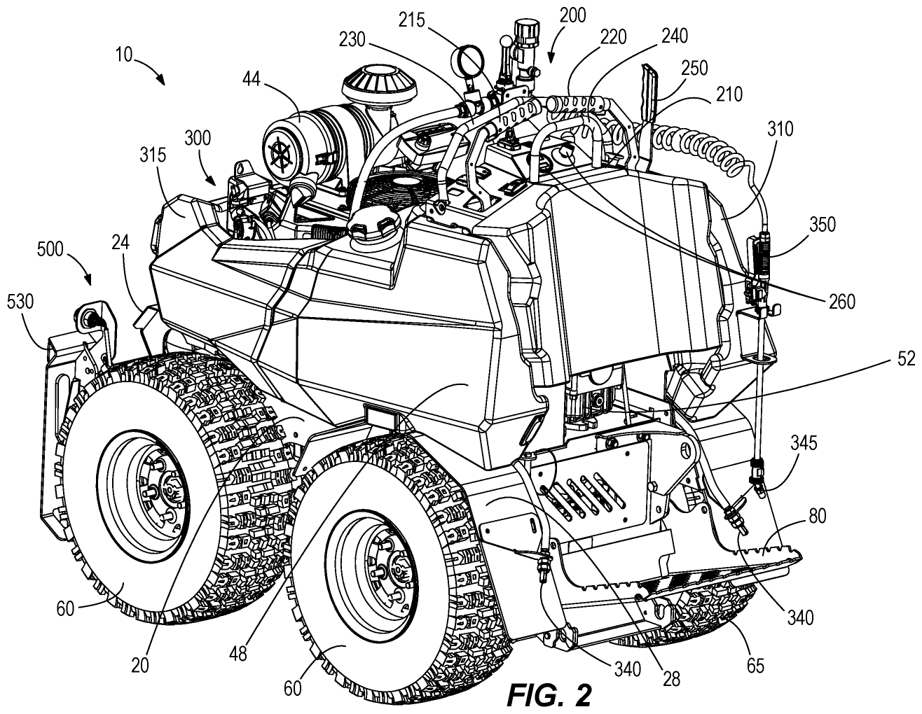

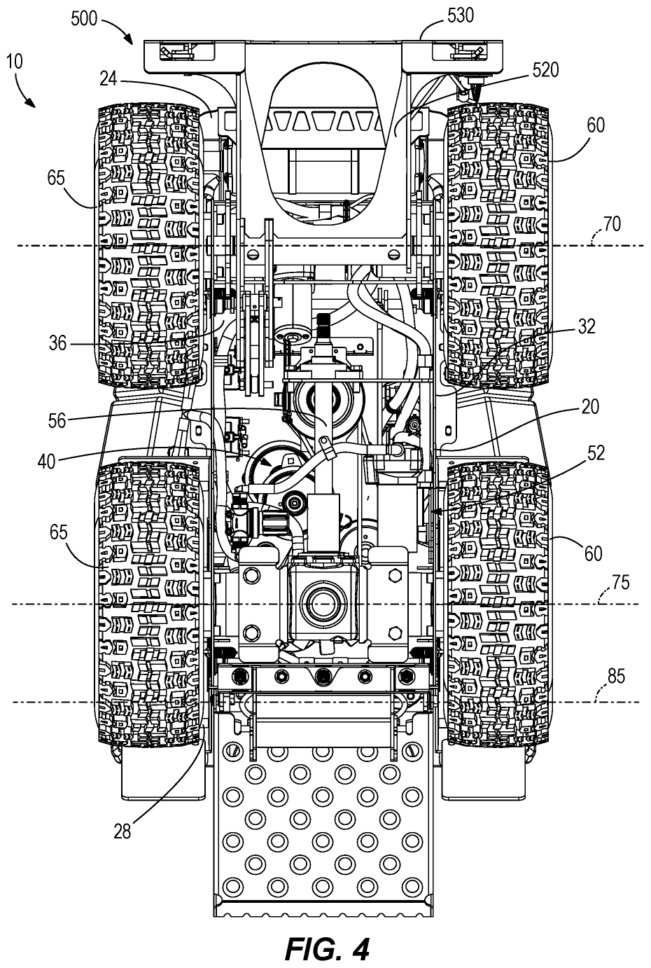

The vehicle 10 includes a frame 20, a skid steer drive assembly 40 (FIG. 4), ground engaging elements 60, 65, an operator platform 80 coupled to the frame 20, an operator interface 200 positioned proximate the operator platform 80, a brine assembly 300 coupled to the frame 20, a light assembly 400 supported relative to the frame 20, and an implement support assembly 500 coupled to the frame 20 and configured to selectively receive the implement 510 (FIG. 6.) in front of the frame 20. The frame 20 includes a front end 24 (FIG. 1), a rear end 28 (FIG. 2) opposite the front end, a first or left side 32 (FIG. 1) extending between the front and rear ends, and a second or right side 36 (FIG. 5) extending between the front and rear ends 24, 28.

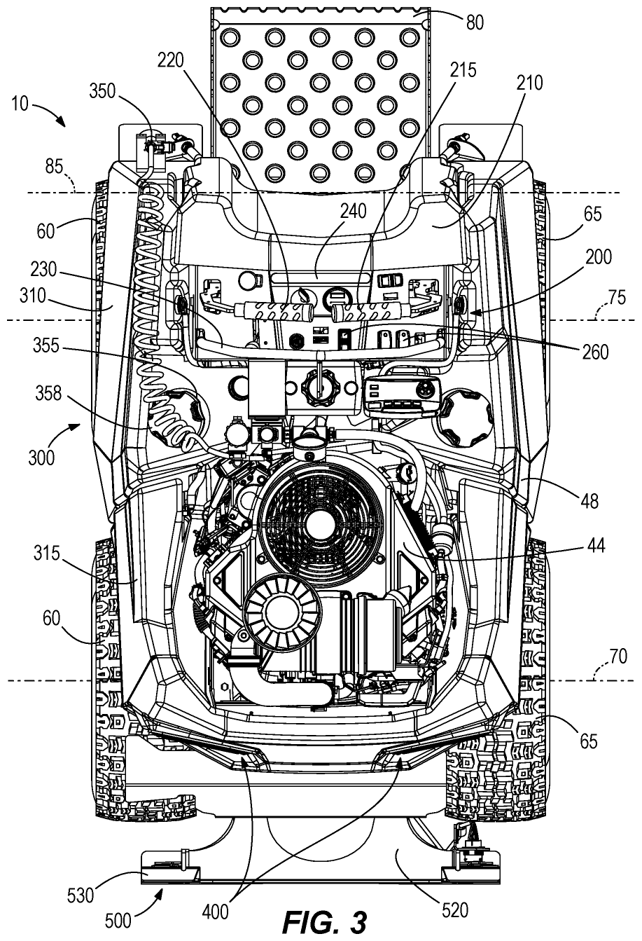

With reference to FIGS. 3 and 4, the skid steer drive assembly 40 (FIG. 4) includes an internal combustion engine 44 (FIG. 3) mounted to the frame 20, a fuel tank 48 (FIG. 3) coupled to the frame 20 to provide fuel to the engine 44, and a hydraulic system 52 (FIG. 4) operably coupled to the ground engaging elements 60, 65. As shown in FIGS. 1 and 3, the internal combustion engine 44 is mounted to a top portion of the frame 20 (e.g., above a front drive axis 70 and a rear drive axis 75 of the ground engaging elements 60, 65). The brine assembly 300 and the fuel tank 48 extend around the front, right side, left side, and a portion of the rear of the engine 44 to define a body of the vehicle 10 such that all sides of the engine 44 are substantially enclosed by the brine assembly 300 and fuel tank 48, while the top of the engine 44 is exposed. It should be appreciated that the body of vehicle 10 may include any elements of structures coupled to and supported by the frame 20.

As shown in FIG. 4, the internal combustion engine 44 (FIG. 3) drives the hydraulic system 52 to rotate the ground engaging elements 60, 65 and also drives a rotating output shaft or power takeoff shaft (PTO) 56 that may be coupled to an implement (e.g., such as a snow blower, brushroll, etc.) to drive a work implement member. In some embodiments, the vehicle may include a single reservoir coupled to a two-stage hydraulic pump (e.g., having a single input and two outputs). The hydraulic pump may drive the ground engaging elements 60, 65. In other embodiments, the vehicle 10 may include separate hydraulic pumps and reservoirs to respectively drive the ground engaging elements 60. The hydraulic system 52 (FIGS. 2 and 4) also applies the torque to respective left and right ground engaging elements 60, 65 in response to an input from the operator interface 200. In the illustrated embodiment, the ground engaging elements 60, 65 include a pair of left drive wheels 60 (front and rear) and a pair of right drive wheels 65 (front and rear). The left drive wheels 60 are hydraulically coupled and the right drive wheels 65 are hydraulically coupled. “Hydraulically coupled” means that the pairs of wheels 60, 65 are simultaneously and synchronously driven by the hydraulic system 52 and neither of the pair can be driven independently of the other. The drive wheels 60, 65 support the frame 20 and rotate under the influence of the skid steer drive assembly 40 to move the vehicle 10 across the ground surface.

In other embodiments of the invention, the internal combustion engine 44 is replaced with an electric motor or any other suitable prime mover (e.g., a hybrid gas/electric motor, a fuel cell, or any other suitable device operating on a suitable fuel). If a prime mover capable of modulating speed is employed (e.g., an electric motor), the hydraulic system (hydraulic pump and hydraulic motor) can be dispensed with and the primary mover can provide power directly to the differential. In other embodiments the drive wheels 60, 65 could be replaced with track drives or any other suitable tractive elements. Left and right drive shafts of the front wheels are coaxial about the front drive axis 70 and the left and right drive shafts of the rear wheels are coaxial about the rear drive axis 75. The front and rear drive axes 70, 75 can collectively be referred to as the drive shafts of the vehicle 10.

With reference to FIGS. 2 and 4, the operator platform 80 is pivotably coupled to the rear end of the frame 20 and positioned rearward of the frame 20. The operator platform 80 is configured to support an operator in a standing position and provide access to the operator interface 200, which is positioned in front of the operator platform 80. In other words, at least a portion of the operator platform 80 is positioned rearward of the operator interface 200 and a rearward-most ground engaging element 60, 65 (e.g., the rear wheels). The operator platform 80 is pivotally mounted to the frame 20 about an axis 85 (FIG. 4) that is rearward of the rear drive axes 75 and the platform 80 is entirely rearward of the rear drive axes 75. In some embodiments, a suspension system or vibration dampening mechanism may be positioned between the frame 20 and the operator platform 80.

The operator interface 200 is positioned on top of a vertical structure or control tower 210 and is accessible by the operator standing on the platform 80. The operator interface 200 comprises a plurality of handles, levers, switches, or the like which are configured to control operation of one or more components (e.g., drive assembly, interface support assembly, implement, etc.). In the illustrated embodiment, the operator interface 200 includes a pair of control levers 215, 220, a first or front speed limiter 230 and a second or rear speed limiter 240, which respectively restrict forward and rearward movement of the control levers 215, 220. In the illustrated embodiment, the first speed limiter 230 is pivotably coupled on top of the control tower 210, which allows the operator to adjust the forward range of the control levers 215, 220 and therefore the speed of the vehicle 10. The operator interface 200 also includes a parking brake 250 to selectively restrict movement of the vehicle 10 and one or more hand controls 260. The hand controls 260 may include multiple functions that can be manipulated by the operator's hands. Some examples of hand controls 260 include: an implement control for transmitting power from the engine 44 to adjust the position of the interface support assembly, a brine control to dispense brine from the brine assembly 300, a light switch, an engine throttle, an engine choke, an engine kill switch, and a hydraulic motor or pump control for controlling the speed and direction of operation of the drive wheels 60, 65. In other constructions, the hand controls 260 may include additional controls to operate other implements coupled to vehicle 10.

As shown in FIGS. 3-5, the brine assembly 300 is coupled to the frame 20 forward of at least a portion of the operator platform 80. In the illustrated embodiment, the brine assembly 300 includes a first fluid or brine tank 310, a second fluid or brine tank 315 that is in fluid communication with first brine tank 310, an outlet hose (not shown) in fluid communication with both the first and second brine tanks 310, 315. The first brine tank 310 includes an inlet 355 (FIG. 3) having a cap 358 removably coupled thereto. The inlet 355 is configured to receive a fluid (e.g., brine). One or more of nozzles 340, 345 are coupled to the outlet hose downstream a pump (not shown) that draws the fluid from the brine tanks 310, 315 through the outlet hose to dispense the fluid through the nozzles 340, 345. The nozzles 340, 345 are coupled to the vehicle 10 rearward of the ground engaging elements 60, 65 to disperse the fluid behind the vehicle 10 during operation. Further, the nozzles 340 are rigidly coupled to the vehicle 10 and the nozzle 345 is coupled to a hand wand 350 that is removably coupled to the vehicle 10. The hand wand 350 is coupled to the vehicle 10 proximate the operator platform 80 so the operator can selectively dispense brine to a desired area surrounding the vehicle 10.

As shown in FIG. 5, the implement support assembly 500 is pivotably coupled to the front end 24 of the frame 20. The implement support assembly 500 is configured to removably receive the implement 510 such as a snowplow having an implement arm 515. The implement support assembly 500 includes an interface support frame 520 pivotably coupled to the vehicle frame 20, an implement interface 530 coupled to the interface support frame 520 and configured to receive the implement arm 515 of the implement 510, and a hydraulic cylinder (not shown) configured to adjust the position (e.g. vertical or pitch position) of the interface support frame 520 and the implement 510 in response to an input from the operator interface 200. In the illustrated embodiment, the hydraulic cylinder is an electric over hydraulic actuator. The implement support assembly 500 further includes an electrical connector 560 supported relative to the interface support frame 520. The electrical connector 560 may be coupled to the implement 510 to drive a working member of the implement. In some embodiments, the implement (e.g., such as a plow) may include a secondary hydraulic cylinder coupled to the electrical connector 560, which allows the operator to adjust a yaw position of the implement 510 (e.g., using the operator interface 200). In other embodiments, the implement (e.g., such as a snow blower, brushroll, etc.) may include an output or work shaft that is coupled to the PTO shaft 56 to drive a working member (e.g., snow blower, brush roll, etc.) of the implement, which allows the operator to selectively activate the working member of the implement to perform a function.

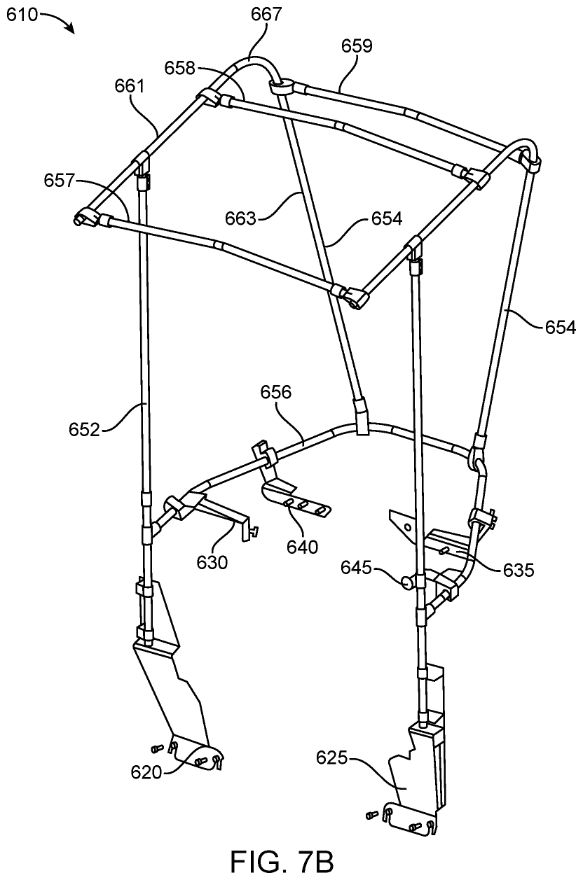

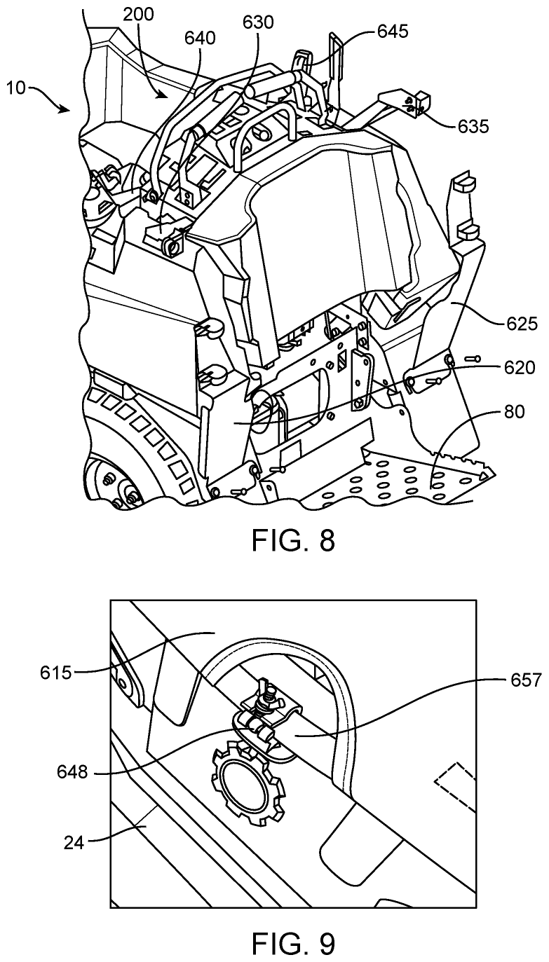

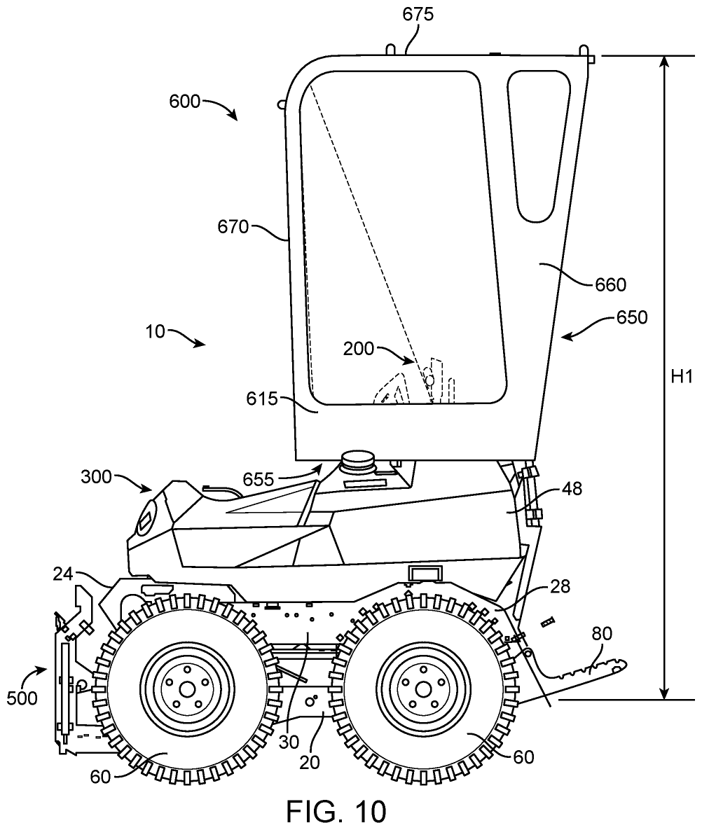

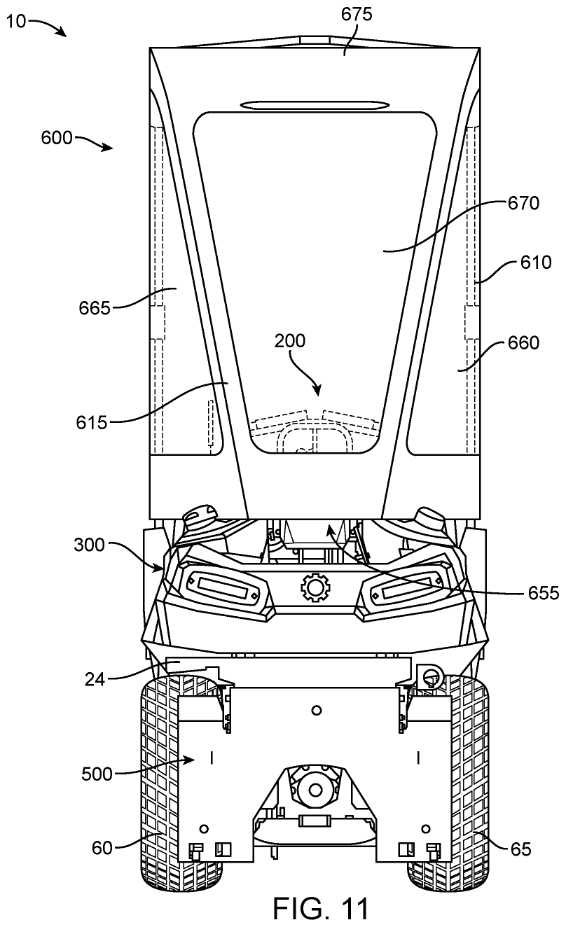

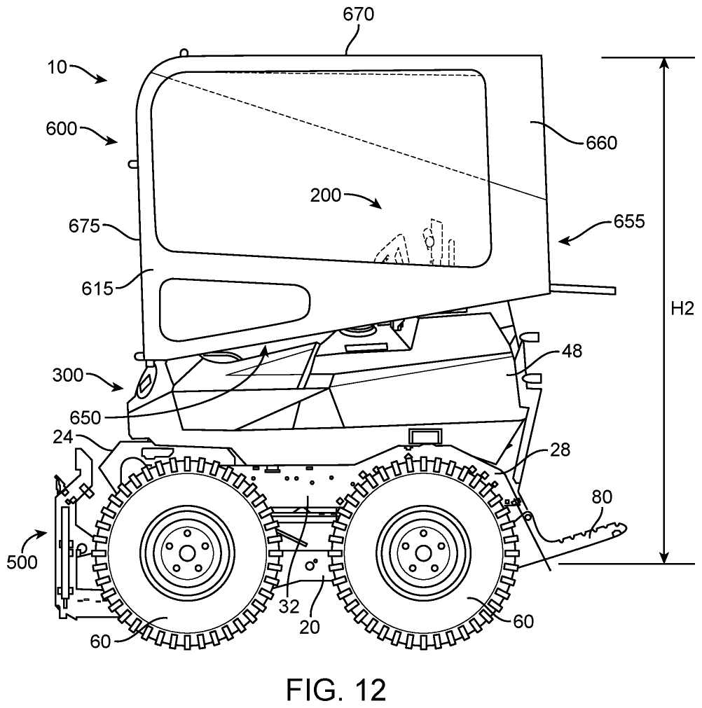

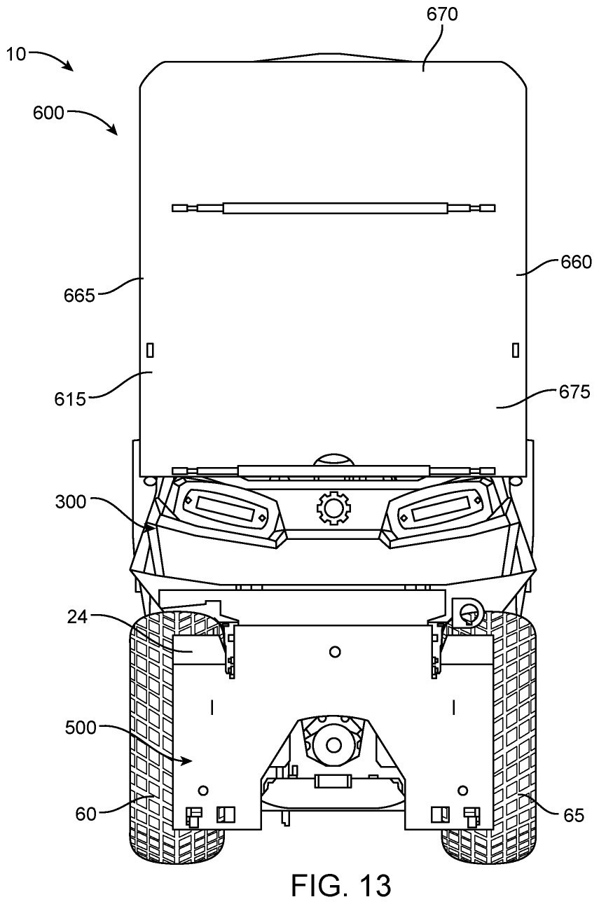

Now with reference to FIGS. 6-11, a cab 600 is removably coupled to the body of the vehicle 10. The cab 600 includes a support frame 610 and an enclosure 615 coupled to the support frame 610. A plurality of brackets 620, 625, 630, 635, 640, 645 (FIG. 8), 648 (FIG. 9) couple the support frame 610 to the vehicle 10. As described in more detail below, the cab 600 is movable between a first, operating position (FIGS. 10 and 11) and a second, storage or transportation position (FIGS. 12 and 13). In the operating position, the cab 600 is in an upright position, which shields an operator standing on the operator platform 80 from wind and/or precipitation. In the storage or transportation position, the cab 600 spans a majority of an overall length of the vehicle (e.g. between the front end 24 and rear end 28 of the frame 20) and covers at least a portion of the engine 44 (FIG. 1). It should be appreciated that a majority of the overall length of the vehicle 10 means that the cab 600 spans across at least 50 percent of the overall length of the vehicle 10. In other words, the cab 600 extends horizontally towards the front end of the vehicle 10. It should also be appreciated that while the cab 600 includes a single position for both storage and transportation of the vehicle 10, that the cab 600 may include a third position specifically design for transportation or storage. In other words, it should be appreciated that the storage position and transportation position may be different and still be within the scope of the invention.

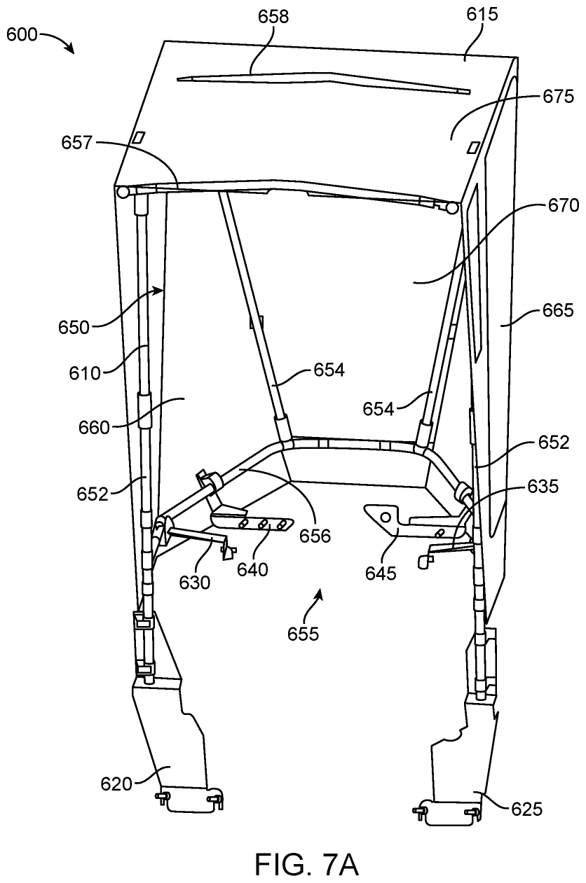

As illustrated in FIGS. 7A and 7B, the support frame 610 is constructed of a plurality of tubes or support members and defines the overall geometry of the cab 600. For example, the support frame 610 is formed from a plurality of metal (e.g., aluminum) or plastic tubes that are connected by joints (e.g., plastic or steel joints). In other embodiments, the support frame 610 is formed as a unitary structure or from other materials (e.g., steel, or the like). The support frame 610 defines a three-dimensional structure having six faces or sides. In some embodiments, the support frame 610 may define a polyhedron structure having at least six faces or sides (e.g. six, seven, eight, etc.). In other embodiments, the three-dimensional structure may have 5 sides.

As illustrated in FIG. 7B, the support frame 610 includes a first pair of vertical members 652, a second pair of vertical members 654, a first cross member 656 coupling a first end of the second pair of vertical members 654 to the second pair of vertical members 654, and a second, third, and fourth cross member 657, 658, 659 coupling the second pair of vertical members 654 together between the first and second ends of the second pair of vertical members 654. For example, the second pair of vertical members 654 have a generally L-shaped geometry defining a first portion 661 (e.g., a horizontal portion), a second portion 663 (e.g., a vertical portion), and an arc 667 between the first and second portions 661, 663. The first cross member 656 has a generally U-shaped geometry to couple the first and second pair of vertical members 652, 654 together. The second cross member 657 couples the second end of the first pair of vertical members 652 together (e.g., the horizontal portion 661), the third cross member 658 couples the first portion 661 of the first pair of vertical members 652 together proximate the arc 667, and the fourth cross member 659 (FIG. 7B) the second portion 663 of the first pair of vertical members 652 together proximate the arc 667.

The enclosure 615 is coupled to the support frame 610 and is configured to shelter the operator from wind and/or precipitation. The enclosure 615 is be coupled to the support frame 610 with hook and loop connections. In other embodiments, the enclosure 615 may be alternatively coupled to the support frame 610. The enclosure 615 is coupled to four sides of the support frame 610 such that a first opening 650 and a second opening 655 (FIG. 7A) are formed in the cab 600. In the illustrated embodiment, the first opening 650 and the second opening 655 are oriented on adjacent faces of the polyhedron structure of the support frame 610. For example, the first opening 650 is defined between the first pair of vertical members 652 and the second opening 655 is defined by the first cross member 656.

The enclosure 615 includes a first panel 660 (e.g., a left side panel), a second panel 665 (e.g., a right side panel), a third panel 670 opposite the first opening 650 and extending between the first and second panels 660, 665, and a fourth panel 675 opposite the second opening 655 and extending between the first and second panels 660, 665. In the illustrated embodiment, the enclosure 615 is constructed of multiple material such that the operator is able to see through at least of portion of the enclosure 615. For example, the enclosure 615 may be formed with a combination of canvas and vinyl. In other embodiments, the enclosure 615 may be formed of a single material. In some embodiments, a fifth panel (not shown) may be removably coupled to the cab 600 to close the first opening 650 and enclose the operator completely within cab 600. In such an embodiment, after the operator enters the operator platform 80 the fifth panel may be coupled to the support frame 610 or the panels 660, 665 via a hook and loop connection, a zipper, or the like. In some embodiments, a sixth panel (not shown) may be removably coupled to the cab 600 to close the second opening 655 when the cab 600 is in the storage or transportation position to fully seal off operator interface 200 (e.g., to provide 360 degree shelter). In other words, the enclosure 615 is coupled to at least four sides of the support frame.

Now with reference to FIGS. 8 and 9, the plurality of brackets 620, 625, 630, 635, 640, 645, 648 include a first bracket 620 and a second bracket 625 coupled to the vehicle 10 proximate the operator platform 80, third, fourth, fifth, and sixth brackets coupled to the vehicle 10 proximate the operator interface 200, and a seventh bracket 648 (FIG. 9) coupled to the vehicle 10 proximate the front end 24. Each bracket 620, 625, 630, 635, 640, 645, 648 includes one or more quick connect clamps that selectively couple the support frame 610 to the vehicle 10. While the brackets 620, 625, 630, 635, 640, 645, 648 are illustrated as quick connect clamps, it should be appreciated that other brackets (e.g., plastic clamps, metal clamps, or the like) are used to selectively attach the support frame 610 to the vehicle 10. In other embodiments, more (e.g., eight, nine, etc.) or fewer (e.g., six, five, etc.) brackets are used to couple the support frame 610 to the vehicle 10.

Now with reference to FIGS. 7, 10 and 11, when the cab 600 is in the operating position (FIGS. 10 and 11), the first opening 650 is positioned adjacent the operator platform 80 and the second opening 655 is positioned adjacent the operator interface 200. The construction of the cab 600 efficiently shields the operator from wind and/or precipitation while allowing the operator to access the operator interface 200 (FIG. 10) from the operator platform 80. To secure the cab 600 in the operating position, the first pair of vertical members 652 (FIG. 7A) are respectively coupled to the first and second brackets 620, 625 while the first cross member 656 is coupled to the third, fourth, fifth, and sixth brackets 630, 635, 640, 645.

In the operating position, the third panel 670 defines a front portion of the cab 600 and the fourth panel 675 defines a roof or uppermost portion of the cab 600. A first height H1 is defined between the fourth panel 675 of the enclosure 615 and the operator platform 80. The first height H1 is large enough to accommodate an operator (e.g., 6-8 feet tall). In addition, the operator is not fully enclosed by the cab 600 so the operator can easily access the operator platform 80 and the operator interface 200 without removing panels. In other words, a majority of the cab 600 is coupled to the vehicle 10 in front of the operator platform 80 while a portion of the fourth panel 675 extends over at least a portion of the operator platform 80.

Now with reference to FIGS. 12 and 13, when the cab 600 is in the storage or transportation position, the first opening 650 spans along the body of the vehicle 10 (e.g., at least partially between the front and rear ends 24, 28) so the third panel 670 encloses the top of the engine 44, the fourth panel 675 is positioned proximate the front end 24 of the vehicle, and the second opening 655 is positioned adjacent the operator interface 200. In other words, the third panel 670 is substantially parallel to a ground surface the vehicle 10 is supported on and the fourth panel 675 is substantially perpendicular to the ground surface.

A second height is defined between the third panel 670 (e.g., an uppermost portion of the cab 600) of enclosure 615 and the operator platform 80. The second height H2 of the cab 600 in the storage or transportation position is less than the first height H1 of the cab 600 in the operating position, which reduces the overall height of the vehicle 10 so the operator can efficiently store or transport the vehicle 10. To move the cab 600 to the storage or transport position, the first pair of vertical members 652 (FIG. A) are respectively coupled to the third, and fourth brackets 630, 635 (FIG. 8). In the transportation position, the second cross member 657 is also coupled to the seventh bracket 648 (FIG. 9).

Although the invention has been described in detail with reference to certain preferred embodiments, variations and modifications exist within the scope and spirit of one or more independent aspects of the invention as described.

Various features of the invention are set forth in the following claims.

What is claimed is:

1. A stand-on utility machine comprising:
a frame having a front end and a rear end;
a prime mover supported by the frame;
a skid steer drive assembly operably coupled to the prime mover;
a plurality of ground engaging elements supporting the frame with respect to a ground surface, the ground engaging elements being operable under the influence of the skid steer drive assembly to move the utility machine over the ground surface;
an operator interface positioned on top of a control tower;
an operator platform coupled to the frame and configured to support an operator so the operator interface is accessible by the operator standing on the platform, a portion of the operator platform being rearward a portion of the ground engaging elements; and
a cab removably coupled to the frame proximate the operator interface, the cab being movable between an operating position and one or more of a storage position or a transportation position.

2. The utility machine of claim 1, wherein the cab is in an upright position to shelter the operator standing on the operator platform from wind and precipitation when the cab is in the operating position, and wherein the cab spans a majority of an overall length of the machine in the storage position or the transportation position.

3. The utility machine of claim 1, wherein
the cab includes a support frame, and an enclosure coupled to the support frame, and
a plurality of brackets configured to couple the support frame to the machine.

4. The utility machine of claim 3, wherein the support frame defines a three-dimensional structure having at least six sides.

5. The utility machine of claim 4, wherein the enclosure is coupled to four sides of the support frame such that a first opening and a second opening are formed in the cab.

6. The utility machine of claim 5, wherein the first opening and the second opening are oriented on adjacent faces of the three-dimensional structure of the support frame.

7. The utility machine of claim 5, wherein the enclosure includes a first panel, a second panel, a third panel opposite the first opening and extending between the first and second panels, and a fourth panel opposite the second opening and extending between the first and second panels.

8. The utility machine of claim 7, wherein the first opening is positioned adjacent the operator platform and the second opening is positioned adjacent the operator interface when the cab is in the operating position.

9. The utility machine of claim 7, wherein the first opening spans at least partially between the front end and the rear end so the third panel encloses a top portion of the prime mover, the fourth panel is positioned proximate the front end of the machine, and the second opening is positioned adjacent the operator interface when the cab is in the storage position or the transportation position.

10. The utility machine of claim 1, wherein the prime mover is an internal combustion engine, and wherein a fuel tank is supported by the frame and configured to provide fuel to the internal combustion engine.

11. The utility machine of claim 1, further comprising an implement support assembly coupled to the frame and supported in front of the ground engaging elements, and wherein the implement support assembly is configured to removably receive an implement.

12. A stand-on utility machine comprising:
a frame having a front end and a rear end;
a prime mover supported by the frame;
a plurality of ground engaging elements supporting the frame with respect to a ground surface, the ground engaging elements being operable under the influence of the prime mover to move the utility machine over the ground surface;
an operator interface positioned on top of a control tower;
an operator platform coupled to the frame and configured to support an operator so the operator interface is accessible by the operator standing on the platform, a portion of the operator platform being rearward a portion of the ground engaging elements; and
a cab removably coupled to the frame proximate the operator interface, the cab being movable between a first position where a first height is defined between the operator platform and an uppermost portion of the cab and a second position where a second height is defined between the uppermost portion of the cab and the operator platform,
wherein the second height is less than the first height.

13. The utility machine of claim 12, wherein
the cab includes a support frame, and an enclosure coupled to the support frame, and
a plurality of brackets configured to couple the support frame to the machine.

14. The utility machine of claim 13, wherein the support frame defines a three-dimensional structure having at least six sides.

15. The utility machine of claim 14, wherein the enclosure is coupled to four sides of the support frame such that a first opening and a second opening is formed in the cab.

16. The utility machine of claim 15, wherein the enclosure includes a first panel, a second panel, a third panel opposite the first opening and extending between the first and second panels, and a fourth panel opposite the second opening and extending between the first and second panels.

17. The utility machine of claim 16, wherein the first opening is positioned adjacent the operator platform and the second opening is positioned adjacent the operator interface when the cab is in the first position.

18. The utility machine of claim 16, wherein the first opening spans at least partially between the front end and the rear end so the third panel encloses a top portion of the prime mover, the fourth panel is positioned proximate the front end of the machine, and the second opening is positioned adjacent the operator interface when the cab is in the second position.

19. A stand-on utility machine comprising:
a frame having a front end and a rear end;
a prime mover supported by the frame;
a ground engaging element coupled to the frame and supporting the frame with respect to a ground surface;
a plurality of ground engaging elements supporting the frame with respect to a ground surface;
an operator interface positioned on top of a control tower;
an operator platform coupled to the frame and configured to support an operator so the operator interface is accessible by the operator standing on the platform; and
a cab coupled to the frame proximate the operator interface, the cab defining a roof that extends at least partially over the operator platform.

20. The utility machine of claim 19, wherein the cab further comprises
a support frame defining a three-dimensional structure having at least six sides,
an enclosure coupled to at least four sides of the support frame, and
a plurality of brackets configured to removably couple the support frame to the machine.
